(19) United States
(12) Patent Application Publication
(10) Pub. No.: US 2016/0186078 A1
(43) Pub. Date: Jun. 30, 2016

(54) C-CONVERTER HAVING A FILTERING FUNCTION

(71) Applicant: CCP TECHNOLOGY GMBH, München (DE)

(72) Inventor: Olaf Kuhl, Greifswald (DE)

(21) Appl. No.: 14/911,736

(22) PCT Filed: Aug. 12, 2014
(86) PCT No.: PCT/EP2014/025004

§ 371 Date: Feb. 12, 2016

(30) Foreign Application Priority Data
Aug. 12, 2013 (DE) 10 2013 013 443.9

(51) Int. Cl. C10J 3/04; C10K 1/02; C01B 31/18; C10J 3/20

(52) U.S. Cl. CPC C10J 3/04; C10J 3/20; C10K 1/024; C01B 31/18; C10J 2300/095; C10J 2300/0969; C10J 2300/0976; C10J 2300/1238; C10J 2300/183

(57) ABSTRACT

A C-converter includes at least one aerosol converter inlet for an aerosol comprising a first gas and particles containing carbon; at least one converter gas inlet for a second gas; at least two converter chamber outlets and at least two converter chambers which are adapted to be filled with particles between a minimum and a maximum particle filling degree. The C-converter also includes at least one diverting device which is adapted to selectively connect a fraction of the converter chambers a) to at least one of the aerosol converter inlets for aerosol or b) to at least one of the converter gas inlets for the second gas or may disconnect the converter chambers therefrom; and at least one discharging device which is adapted to selectively connect a fraction of the converter chambers to at least one of the converter outlets or to disconnect the converter chambers therefrom.

### RELATED APPLICATIONS

This application corresponds to PCT/EP2014/025004, filed Aug. 12, 2014, which claims the benefit of German Application No. 10 2013 013 443.9, filed Aug. 12, 2013, the subject matter of which are incorporated herein by reference in their entirety.

### BACKGROUND OF THE INVENTION

The present invention relates to a C-converter (carbon converter) an apparatus incorporating a C-converter and methods for using the same.

DE 10 2012 008 933 discloses a method and an apparatus for producing carbon monoxide, wherein carbon monoxide is produced from carbon dioxide in the presence of carbon at a temperature of more than 850° C. Furthermore DE 10 2012 010 542 discloses a method and an apparatus for producing a synthesis gas. In both of the above mentioned prior art methods, a stream of hot particles containing carbon is directed into a carbon converter. In these prior art methods, conversion in the carbon converter may be incomplete. Furthermore, heat losses may occur, which affect the cost effectiveness of these known methods. In the known methods and apparatuses, particles may deposit in the converter which may cause interruptions of the operation.

U.S. Pat. No. 6,077,490 A discloses an apparatus for filtering hot synthesis gas which comprises a filter having two filter chambers, which are used alternately as filter and cleaned. During operation, hot synthesis gas containing unreacted carbon soot is directed into one of the filter chambers. As soon as too much carbon soot has accumulated, the cleaning step is carried out by admitting air, i.e. N₂ and O₂, in a reverse flow. The accumulated carbon is burnt off. Thus, inert gas purge which leads to accumulations of soot may be avoided. U.S. Pat. No. 5,809,911 A discloses a waste treatment system which burns or melts mixed waste materials. Stable effluent gasses are treated in a gaseous effluent processing subsystem, which includes a high temperature filter. The high temperature filter comprises two filter elements, which filter particles entrained in the effluent gasses and are operated in parallel. The filter elements may be backflushed in parallel with air (i.e. N₂ and O₂), N₂ or steam. The backflushed particles will settle on the waste combustion bed where the particles mix with the slag.

### SUMMARY

Accordingly, the object of the present invention is to provide a carbon converter and a method of operating the carton converter which may overcome at least one of the above problems, in particular enables long and uninterrupted periods of operation, and wherein the materials directed into the converter may be completely converted.

This problem is solved by a C-converter comprising at least one aerosol converter inlet for an aerosol comprising a first gas (hydrogen) and particles containing carbon; furthermore at least one converter gas inlet for a second gas (H₂O or exhaust gas containing CO₂); at least two converter outlets; and at least two converter chambers each comprising at least one filter adapted to filter particles containing carbon from the aerosol. The C-converter further comprises at least one diverting device adapted to alternately connect a fraction of the at least two converter chambers with a) at least one aerosol converter inlet or b) with least one converter gas inlet; and at least one discharging device adapted to alternately connect a fraction of the at least two converter chambers with at least one of the converter outlets or to disconnect the same. The C-converter is able to convert aerosols containing carbon particles without interruption, and a high degree of conversion of the materials supplied into the converter maybe achieved. The aerosol consists of carbon particles and hydrogen. Thus, no residual materials remain, and the supplied materials are completely converted. The at least one aerosol converter inlet is connected to at least one hydrocarbon converter adapted to operate with plasma and adapted to decompose fluids containing hydrocarbons into an aerosol comprising particles containing carbon and hydrogen.

In one embodiment of the C-converter, the second gas is an exhaust gas containing CO₂, such as from an industrial plant, particularly from a power plant or a blast furnace. Thus, CO₂, which is detrimental to the climate, may be converted inside the C-converter into carbon monoxide which is a chemical base material. Alternatively, the second gas is H₂O steam (water steam). Thus the aerosol may be converted into a CO/H₂ gas mixture inside the C-converter, wherein the CO/H₂ gas mixture is referred to as synthesis gas and serves as a chemical base material.

Preferably, the filter is a heat resistant mesh filter or a ceramic filter, since high temperatures prevail in the C-converter so as to achieve fast and complete conversion of the particles containing carbon.

Preferably, the converter chambers of the C-converter comprise a porous ceramic base as a filter and a ceramic shell. Thus a simple construction of the converter chambers may be achieved and a long service life may be ensured.

Preferably, the converter chambers are arranged side by side, to obtain a heat transfer from one converter chamber to an adjacent converter chamber. During operation, hot aerosol is supplied alternately into the converter chambers and, as soon as the converter chambers are filled to a pre-determined particle filling degree with particles containing carbon, the converter chambers are regenerated by supplying the second gas thereto at high temperatures. Heat transfer between adjacent converter chambers prevents that a high loss of heat occurring during regeneration periods. An additional heater may be avoided or, at least, may be implemented smaller.

Preferably, the converter chambers are tubular and extend parallel side by side as a tube bundle. The tubular shape may have a cylindrical, triangular, square or hexagonal cross section. Thus, the converter chambers may be adapted to the surrounding structures, which also may heat the converter chambers, particularly if the C-converter is operated in combination with a hydrocarbon converter operated with plasma or with thermal energy.

In one embodiment of the C-converter, gaps are formed between the converter chambers, and the gaps are connected with an inlet and an outlet, which allow to pass a fluid through the gaps. If the second gas is directed through the gaps into the converter chambers, the second gas may be preheated, which contributes to energy savings during operation of the C-converter. If the second gas is steam of water, the steam of water may be produced by injecting liquid water into the gaps during operation. As the converter chambers have a temperature of several hundred degrees Celsius, the liquid water will be vaporized.

In a preferred embodiment, the diverting device comprises at least one aerosol diverting device and at least one gas diverting device. The aerosol diverting device preferably comprises a slide valve or a flap valve. Thus depositions of particles during operation are avoided or at least reduced.

In one embodiment, the each of the converter chambers comprises at least one converter chamber inlet, wherein at least a fraction of the converter chamber inlets of at least two converter chambers is located on a circle. At least one diverting device comprises a rotatable diverting element. Thus, the aerosol converter inlet may be connected to at least one converter chamber inlet via the rotatable diverting element. Thus, the aerosol may be diverted quickly, and a continuous operation of the C-converter may be ensured.

In a preferred embodiment, each of the converter chambers comprises at least one converter chamber outlet, wherein the discharging device for each converter chamber comprises a valve assembly having at least one valve for each converter chamber, wherein the valve assembly is adapted to alternately connect at least one of the at least two converter chamber outlets a) with the first C-converter outlet, or b) with the second converter outlet or c) to disconnect converter chamber outlets from the first and second converter outlets. By use of gas valves, commercially available parts may be used, which reduces costs of the C-converter.

The above mentioned problem is also solved by an apparatus for producing CO or synthesis gas, comprising: at least one hydrocarbon converter operated with plasma or with thermal energy, the hydrocarbon converter having an outer casing and being adapted to decompose fluids containing hydrocarbon into carbon and hydrogen; and at least one C-converter. The C-converter is disposed adjacent to the outer casing of the hydrocarbon converter so as to facilitate a heat transfer from the hydrocarbon converter to the C-converter. During operation of the apparatus, hot aerosol and the second gas are alternately directed to the chambers of the C-converter, and the C-converter converts particles containing carbon into CO or synthesis gas at high temperatures. Heat transfer between the C-converter and the outer casing of the hydrocarbon converter ensures that an additional heater may be avoided or at least reduced in size. Preferably, the at least one C-converter of the apparatus is implemented according to the above mentioned embodiments.

A preferred embodiment of the apparatus comprises a plurality of adjacent hydrocarbon converters wherein at least one gap is formed between the hydrocarbon converters, and wherein one or more converter chambers of at least one C-converter is/are disposed in the at least one gap. Thus, good energy utilization during operation of the apparatus and small installation space may be achieved due to close packing

In one embodiment of the apparatus, the C-converter partially or completely surrounds the hydrocarbon converter at its periphery. Preferably, the C-converter concentrically surrounds the outer casing of the hydrocarbon converter. Thus, a particularly compact construction of the apparatus may be realized, which has good energy utilization during operation.

In one embodiment of the apparatus, fluid conduits are disposed on or in the outer casing of the hydrocarbon converter. Thus, a cooling feature may be provided for the hydrocarbon converter and/or a fluid may be preheated. Preferably, the outer casing of the hydrocarbon converter is free from fluid conduits in a region facing an adjacent C-converter. Thus, cooling of the outer casing of the hydrocarbon converter and at the same time heat transfer to an adjacent C-converter may be achieved.

In a preferred embodiment of the apparatus, at least one of the gaps is connected to an inlet and to an outlet. Thus, a fluid may be directed through the gaps, such that heat transfer between a fluid in the converter chamber and a fluid in the gaps is facilitated. Thus, any structures located near to the hot converter chambers may be cooled, if the fluid is colder than the neighboring structures. If the second gas is directed through the gaps before the second gas is directed into the converter chambers, the second gas may be preheated, which contributes to energy savings during operation of the C-converter. If the second gas is H₂O steam, said H₂O steam may be produced by injecting liquid water into the gaps during operation. Since the converter chambers have a temperature of several hundred degrees Celsius, the liquid water is vaporized.

The above mentioned problem is further solved by a method for operating a C-converter, the C-converter comprising a plurality of converter chambers wherein each of the converter chambers comprises at least one filter, the filter being adapted to filter particles from an aerosol comprising a first gas and particles The method comprises the steps of: Alternately supplying an aerosol containing carbon into at least one first converter chamber or at least one second converter chamber, thereby trapping the particles from the aerosol in the filter, until a desired particle filling degree in the respective converter chamber is reached; and alternately supplying a second gas into the at least one first converter chamber or the at least one second converter chamber so as to regenerate the corresponding converter chamber by converting the particles containing carbon into carbon monoxide, wherein a) the second gas is CO₂ and the conversion is carried out according to the equation C+CO₂→2CO; or b) the second gas is H₂O steam and the conversion is carried out according to the equation C+H₂O→CO+H₂. Aerosols containing carbon particles may be converted by use of this method without any interruptions, and a higher conversion degree of the materials directed into the converter may be achieved.

Preferably, the second gas supply is blocked when the aerosol is supplied to the respective converter chamber, and the first gas is exhausted via a first converter chamber outlet. When the second gas is supplied to the respective converter chamber, the aerosol supply is blocked and the carbon monoxide is exhausted via a second converter chamber outlet.

In one embodiment of the method, the maximum particle filling degree is determined by at least one of the following: a pressure difference across a converter chamber supplied with aerosol, an increase in weight of the converter chamber supplied with aerosol, a filling sensor output, a duration of supplying the aerosol or by a time period of supplying aerosol, and depending on the current particle filling degree of another converter chamber.

In one embodiment of the method, the second gas is supplied until another desired particle filling degree is reached. The other desired particle filling degree is lower than desired particle filling degree. Accordingly, a continuous operation may be achieved.

The method is preferably carried out such that the C-converter is continuously supplied with the aerosol. Thus, the C-converter may cooperate with an aerosol source continuously supplying aerosol even though the converter chambers are alternately supplied with aerosol or the second gas, respectively.

In the method, conversion of C to CO preferably takes place at a temperature above 800° C., wherein a first converter chamber is heated at least partially by at least one of waste heat from at least one adjacent second converter chamber, waste heat of a hydrocarbon converter operated with plasma or with thermal energy and the aerosol. During operation, hot aerosol is alternately directed into the converter chambers and, as soon as the converter chambers are filled to a predetermined particle filling degree with particles containing carbon, the converter chambers are regenerated by supplying the second gas at a high temperature. Heat transfer between adjacent converter chambers prevents a high heat loss during regeneration periods. An additional heater for maintaining the temperature above 800° C. may be avoided or at least reduced in size.

In one embodiment, gaps are formed between the converter chambers, and the method comprises the step of directing a fluid through the gaps such that a heat exchange between a fluid in the converter chambers and the fluid in the gaps may be achieved. Thus, any structures located next to the hot converter chambers may be cooled. If the second gas is directed through the gaps before the second gas is directed into the converter chambers, the second gas may be preheated. If the second gas is H₂O steam, the H₂O steam may be produced by injecting liquid water into the gaps during operation, wherein the liquid water becomes vaporized at temperatures well above the boiling point of 100° C.

Preferably, the aerosol and the second gas are supplied to the converter chamber from opposite sides of the filter, and the first and second converter chamber outlets are arranged on opposite sides of the filter. Thus, the trapped particles may be released from the filter.

A method for operating the above discussed apparatus also solves the above mentioned problem. The method comprises the step of directing a fluid through the gaps between the C-converter and/or the converter chambers of the C-converter and/or the outer casing of the hydrocarbon converter such that a heat exchange is effected between a fluid in the converter chambers and/or in the outer casing and the fluid in the gaps. Thus, any structures next to the hot converter chambers may be cooled. If the second gas is directed through the gaps, the second gas may be preheated. If the second gas is H₂O steam, said H₂O steam may be produced by injecting liquid water into the gaps during operation and vaporizing the liquid water.

### BRIEF DESCRIPTION OF THE DRAWINGS

The invention and further details and advantages thereof will be discussed herein below based on preferred embodiments and referring to the figures.

FIG. 1 is a schematic illustration of a C-converter according to the invention;

FIGS. 2a-2d are illustrations of different configurations and arrangements of converter chambers of the C-converter shown in FIG. 1;

FIGS. 3a-3d are schematic illustrations of embodiments of diverting devices for the C-converter shown in FIG. 1;

FIG. 4 is an illustration of the diverting device shown in FIGS. 3a and 3b in combination with a C-converter having two converter chambers;

FIG. 5 is a schematic illustration of a another embodiment of a C-converter according to the invention;

FIGS. 6a and 6b are schematic illustrations of inlets and outlets of a converter chamber of a C-converter according to the invention;

FIGS. 7a and 7b are schematic illustrations of an apparatus for producing CO or a synthesis gas comprising a C-converter;

FIGS. 8a and 8b are schematic illustrations of further embodiments of an apparatus for producing CO or a synthesis gas having one or more C-converters;

FIG. 9 shows another embodiment of an apparatus for producing CO or a synthesis gas having one or more C-converters;

FIG. 10a shows another embodiment of an apparatus for producing CO or a synthesis gas having one or more C-converters; and

FIG. 10b is a sectional view of the apparatus shown in FIG. 10a along line X-X shown in FIG. 10a.

### DESCRIPTION

It shall be noted that the terms top, bottom, right and left, as well as similar terms as used in the following description relate to the orientations and arrangements, respectively, as shown in the figures and these terms are only meant to be descriptive of the embodiments and should not be interpreted in a limiting manner although they may refer to preferred arrangements.

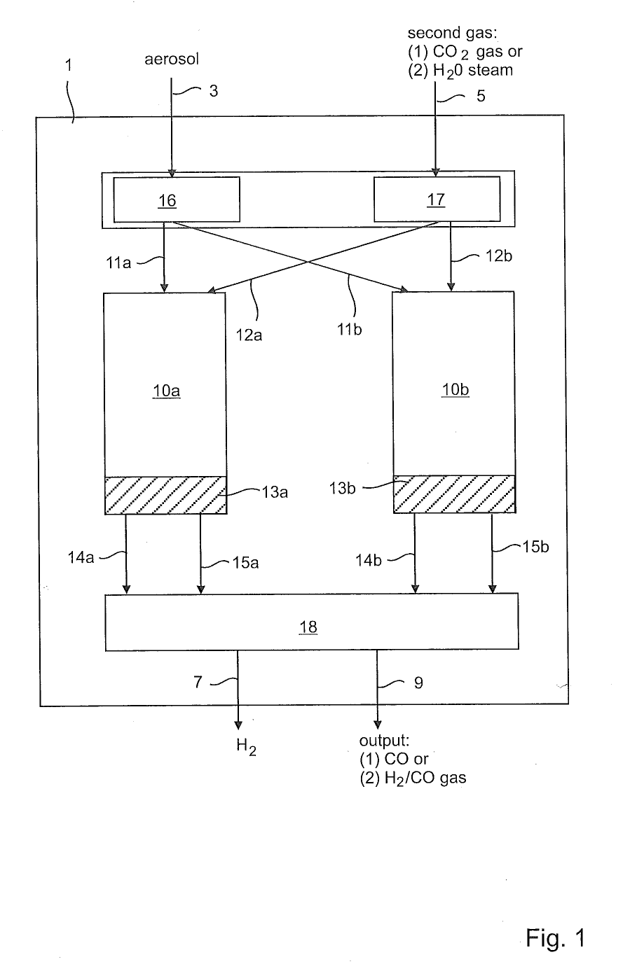

FIG. 1 schematically shows a C-converter 1 (carbon converter) according to the present disclosure. The C-converter 1 comprises an aerosol converter inlet 3, a converter gas inlet 5 and two converter outlets 7 and 9. The aerosol converter inlet 3 may be connected to a source of an aerosol of a gas and particles containing carbon and the converter gas inlet 5 may be connected to a source of a gas such as CO₂ or H₂O-steam (also called water vapor). Furthermore the C-converter 1 comprises two converter chambers 10, i.e. a first converter chamber 10a and a second converter chamber 10b. Each of the converter chambers 10 has a converter chamber inlet 11 for aerosol and a converter chamber inlet 12 for a gas. The term “converter chamber inlet” means any form of conduit which may allow an aerosol or a gas to enter into the converter chamber 10. In a practical implementation the converter chamber inlet 11, 12 may comprise any ductwork, conduit, tube or hose leading to the converter chamber 10, wherein, depending on its length, valves, heating devices and cooling devices may be provided therein/thereon.

Furthermore, a filter 13 is disposed in each of the two converter chambers 10 (a filter 13a in the first converter chamber 10a and a filter 13b in the second converter chamber 10b). The Filters 13 are adapted to trap particles from aerosol directed therethrough. In particular, the filters 13 may trap particles containing carbon from the aerosol, which particles may later be converted by means of a second gas, such as CO₂ or H₂O-steam, as will be described in more detail herein below.

Each of the converter chambers 10 of FIG. 1 has a converter chamber outlet 14 for hydrogen H₂ and a converter chamber outlet 15 for a gas or a gas mixture produced by a conversion of carbon (C) inside the C-converter 1. The term converter chamber outlet is meant to cover any form of means adapted to discharge hydrogen or the gas or gas mixture, respectively, from the converter chamber 10. A converter chamber outlet 14, 15 may for example be a long or short ductwork, conduit, tube or hose conduit connected to the converter chamber 10 and may have one or more of valves, heating devices and cooling devices.

The C-converter 1 comprises an aerosol diverting device 16 located between the aerosol converter inlet 3 and the converter chambers 10. The diverting device 16 is configured to selectively connect the aerosol converter inlet 3 with either the first converter chamber 10a or the second converter chamber 10b. The C-converter 1 further comprises a gas diverting device 17 located between the converter gas inlet 5 and the converter chambers 10. The gas diverting device 17 is adapted to selectively connect the converter gas inlet 5 with either the first converter chamber 10a or the second converter chamber 10b. Alternatively, the aerosol diverting device 16 and the gas diverting device 17 may also be formed as a single combined diverting device (not shown in FIG. 1) for providing the selective connectivity. However, it is currently preferred to provide a separate aerosol diverting device 16 and a separate gas diverting device 17 since the aerosol and the gas have different flow characteristics and material characteristics and may also have different temperatures during operation. Furthermore, the C-converter 1 comprises a discharging device 18 located between the converter chambers 10 and the first and second converter outlets 7, 9. The discharging device 18 is configured to connect the first converter chamber 10a and the second converter chamber 10b with either one of the converter outlets 7, 9, respectively, or to disconnect the converter chambers therefrom.

As indicated above, the aerosol converter inlet 3 is connected to a source of aerosol (not shown in FIG. 1) wherein the aerosol comprises a first gas and particles containing carbon. In the example as shown, the aerosol particularly comprises carbon particles (C) and hydrogen (H₂). The carbon particles are in a powder form. The source of aerosol may be a storage container or an intermediate container. Alternatively, the source of aerosol may be a hydrocarbon converter (preferably a Kvaerner-reactor as described herein below) operating with plasma or with thermal energy for decomposing fluids containing hydrocarbons, thereby producing the aerosol. By decomposing the fluids containing hydrocarbons in a plasma or with thermal energy, the aerosol has a high temperature, which is beneficial for the conversion in C-converter.

The converter gas inlet 5 is connected to a source of a second gas (not shown in FIG. 1). The second gas is at least one of a gas containing CO₂ or H₂O steam.

If the second gas is a gas containing CO₂ (which may also be pure CO₂), said second gas may for example be an exhaust gas from an industrial plant, a power plant, a cement plant, a furnace gas from a (blast) furnace, an exhaust gas from an internal combustion motor or any other combustion process or any other gas containing CO₂. It will be obvious to the skilled person that such a gas containing CO₂ may also comprise significant portions of other components which may not participate in the reactions inside the C-converter 1 (see below), such as but not limited to nitrogen or inert gases. Furthermore, the gas containing CO₂ may comprise minor proportions (less than 5%) of components which may participate in the reactions inside the C-converter 1. However, due to their low proportions, they are not detrimental to the functionality of the C-converter 1 and do not have considerable influence on the conversion processes therein.

If the second gas is H₂O steam (water vapor), such water vapor may be specifically produced for operating the C-converter 1, for example from water supplied for this purpose or the water vapor may come from a cooling process, for example from a cooling tower of a power plant or another industrial plant. Similar to the gases containing CO₂, the water vapor may comprise considerable amounts of components which do not participate in the reactions inside the C-converter 1, such as nitrogen or inert gases, and may also comprise low proportions (less than 5%) of reactive components which do not have a considerable influence on the conversion process.

Depending on the type of the supplied second gas, the following conversions take place inside the C-converter 1 without using catalysts, as will be described in more detail below:

a) if water vapor is supplied: C+H₂O→CO+H₂

b) if carbon dioxide is supplied: C+CO₂→2CO.

If water vapor is supplied, the C-converter 1 produces a CO/H₂ gas mixture which is also referred to as a synthesis gas. If CO₂ is supplied, the C-converter 1 produces CO or a gas containing CO (possibly having inert components or a low proportion of reactive components (less than 5%)), respectively.

The structure and operation of the C-converter 1 will be described herein below for a case wherein a gas containing CO₂ is supplied as a second gas through the converter gas inlet 5, and wherein the above mentioned conversion b) is carried out (Boudouard conversion according to the Boudouard equilibrium).

In a first step, filtering is performed by passing the aerosol through one of the converter chambers. The filter traps the particles containing carbon and passes the H₂ which may be appropriately discharged and preferably collected for other purposes. The filtering step is stopped by stopping the flow of aerosol through the respective converter chamber. In a second step a conversion (also called a regeneration) is performed by passing the second gas (in this case CO₂) through the respective converter chamber. In the conversion, the second gas converts the previously trapped particles containing carbon as disclosed above. The conversion typically takes place at a temperature above 850° C. without utilizing a catalyst.

Filtering and conversion are controlled to alternately take place in the converter chambers 10a and 10b, as will be described in more detail herein below. The position of the aerosol diverting device 16 and the gas diverting device 17 are controlled based on the filling degree of particles in the converter chambers 10. In particular, they are controlled to supply the first and second converter chambers 10a and 10b in an alternating manner with the aerosol and the second gas. In other words, the converter chambers are always only supplied with either the aerosol or the second gas and when the converter chamber 10a is supplied with the aerosol, the converter chamber 10b is supplied with the second gas and vice versa. The discharging device 18 connects the respective converter chambers 10a, 10b with the converter outlet 7, when aerosol is supplied thereto, and to the converter outlet 9, when the second gas (gas containing CO₂, H₂O steam) is supplied.

The filters 13 in the converter chambers 10a and 10b may be filled with particles between a lower desired particle filling degree and an upper desired particle filling degree (also called a desired minimum and maximum particle filling degree). The filling degree depends on the amount of particles containing carbon, which are trapped in the filters 13 (13a, 13b in FIG. 1), when the aerosol is passed therethrough. The upper desired particle filling degree (maximum particle filling degree) may for example correspond to a 70-90% rated filter load of particles containing carbon. The desired maximum particle filling degree may for example be determined based on a pressure drop across a respective converter chamber. It may for example be determined that a desired maximum particle filling degree is reached if a pressure drop across one of the converter chambers 10a, 10b is so high that a desirable or economical operation of the C-converter is no longer ensured. The desired maximum particle filling degree may also be determined in other ways and may actually not be related to the actual filing degree as will be described herein below.

If a desired maximum particle filling degree of the (first) converter chamber 10a on the left hand side in FIG. 1 is reached, supplying aerosol into this converter chamber 10a is stopped and diverted into the other converter chamber 10b. Now, regeneration of the (first) left converter chamber 10a, which is filled to the desired maximum particle filling degree, may begin by supplying the second gas. During regeneration, the particle filling degree of the regenerated converter chamber 10a will decrease, until a desired lower or minimum particle filling degree is reached. The supply of the second gas may be stopped and an aerosol may again be supplied while regeneration may be carried out in the other converter chamber.

In this case, the desired minimum particle filling degree is a predetermined particle filling degree which can be reached after a desirable regeneration time and which provides for sufficient capacity for storing new particles containing carbon in the respective filters in the converter chambers. The minimum particle filling degree may be 0% but may be also a particle filling degree where the filters 13 are loaded with particles containing carbon up to 5-15 percent of the rated filter load. In the above example having two converter chambers 10a, 10b, the flow of the aerosol and of the second gas through the respective converter chambers 10a, 10b is preferably controlled in a manner such that the trapping of particles and the conversion thereof occur approximately at the same speed. This enables a continuous operation of the C-converter.

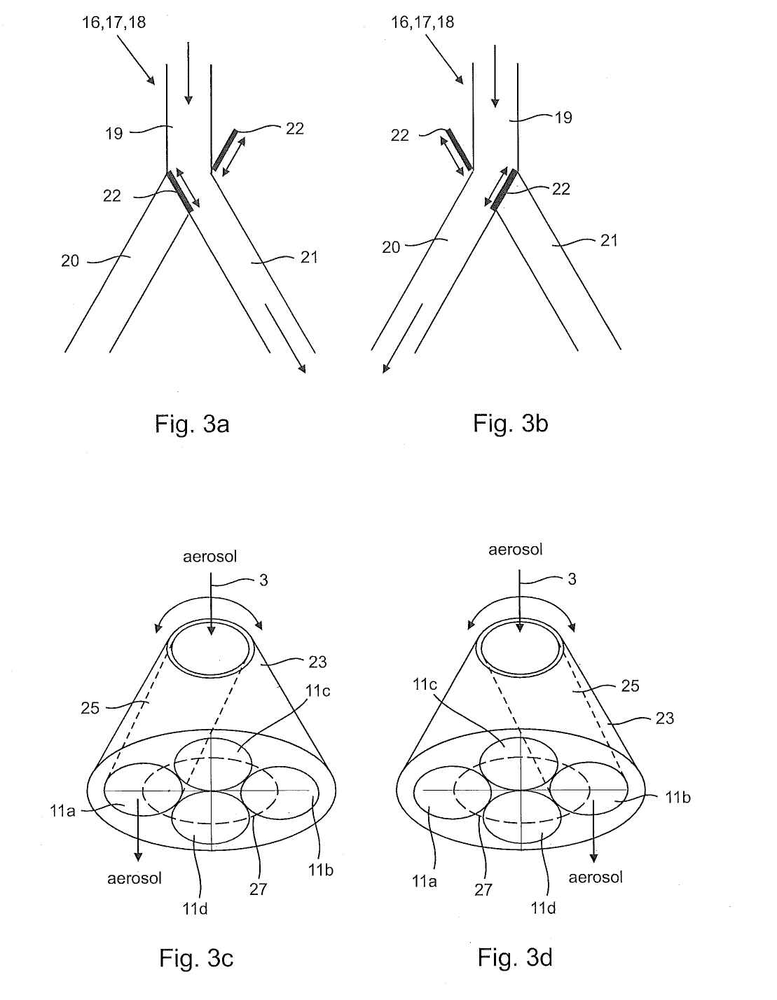

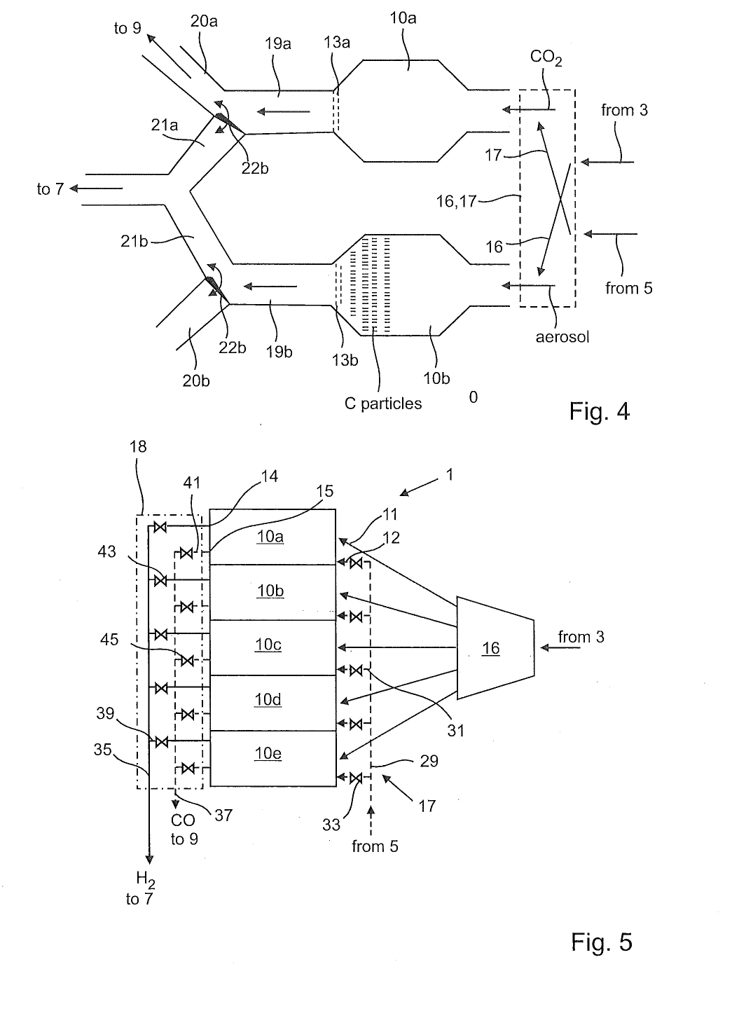

FIGS. 3a to 3d show different examples for the aerosol diverting device 16. Even though the aerosol diverting device 16 is described in this context, the structure as shown is also suitable for the gas diverting device 17 and for the discharging device 18 (see for example FIG. 4). FIGS. 3a and 3b show a first example of the aerosol diverting device 16 in different configurations, and FIGS. 3c and 3d show a second example of the aerosol diverting device 16 in two configurations.

In the example of FIGS. 3a and 3b, an aerosol diverting device 16 for use in combination with two respective converter chambers is shown. The aerosol diverting device 16 comprises an inlet tube 19 connected to the aerosol converter inlet 3. Furthermore, the aerosol diverting device 16 comprises first and second branch tubes 20, 21 each being connected to one respective converter chamber 10 (10a and 10b in FIG. 1). The branch tubes 20, 21 may be connected to or disconnected from the inlet tube 19 via a shutter (closing element) 22. The shutters 22 are slidable, as shown by arrows in FIGS. 3a and 3b. The shutters 22, however, may also be formed as flaps or gates (FIG. 4) or may have any other form adapted to connect or disconnect the inlet tube 19 to or from the respective branch tubes 20 or 21. The shutters 22 are preferably formed in such a way that few or no particle depositions may occur in a region of the transition between the inlet tube 19 and the branch tubes 20, 21. In the configuration of FIG. 3a, an aerosol supplied into the inlet tube 19 will for example be directed to the right hand side into the branch tube 21 (in FIG. 1 directed to the right converter chamber 10b). In the configuration of FIG. 3b, the branch tube 21 is closed by the shutter 22, and aerosol supplied via the inlet tube 19 is guided to the left hand side into the branch tube 20 (in FIG. 1 to the left converter chamber 10a). Preferably, movement of the shutters 22 is locked, such that always one of the branch tubes 20, 21 is connected to the inlet tube 19, while the other is blocked and vice versa.

In FIGS. 3c and 3d, another example of an aerosol diverting device 16 for use in combination with four respective converter chambers is shown. FIGS. 3c and 3d show different configurations of the aerosol diverting device 16. As shown, the aerosol diverting device 16 comprises a rotatable guiding element 23, which is a truncated cone, but other shapes are possible. A conduit 25 passes through the guiding element 23. The guiding element 23 is rotatable around its central axis, i.e. around the rotational axis of the truncated cone. The conduit 25 has an inlet at the upper narrow end of the truncated cone and an outlet at the lower wide end thereof. The conduit 25 is inclined with respect to the rotational axis of the truncated cone, such that upon rotation of the guiding element 23, the (center of the) outlet end is moved along a circle 27.

In FIGS. 3c and 3d, a plurality of converter chamber inlets 11a, 11b, 11c and 11d are schematically indicated by circles. The respective centers of the converter chamber inlets 11a-11d are shown to be arranged on the circle 27 and thus form a circular distribution pattern. As mentioned above, the converter chamber inlets 11 may be of any suitable type for allowing an aerosol to enter therein, such as any longer or shorter conduits (depending on the size and arrangement of the converter chambers 10).

As the skilled person will appreciate, depending on the rotational position of the guiding element 23, the inclined conduit 25 will directed the aerosol to one of the converter chamber inlets 11a or 11b or 11c or 11d. In FIG. 3c, the rotatable guiding element 23 is for example disposed in an orientation wherein the outlet of the conduit 25 opens towards the converter chamber inlet 11a. In FIG. 3d, the rotatable guiding element 23 is rotated by 180°, such that the outlet of the conduit 25 opens towards the converter chamber inlet 11b.

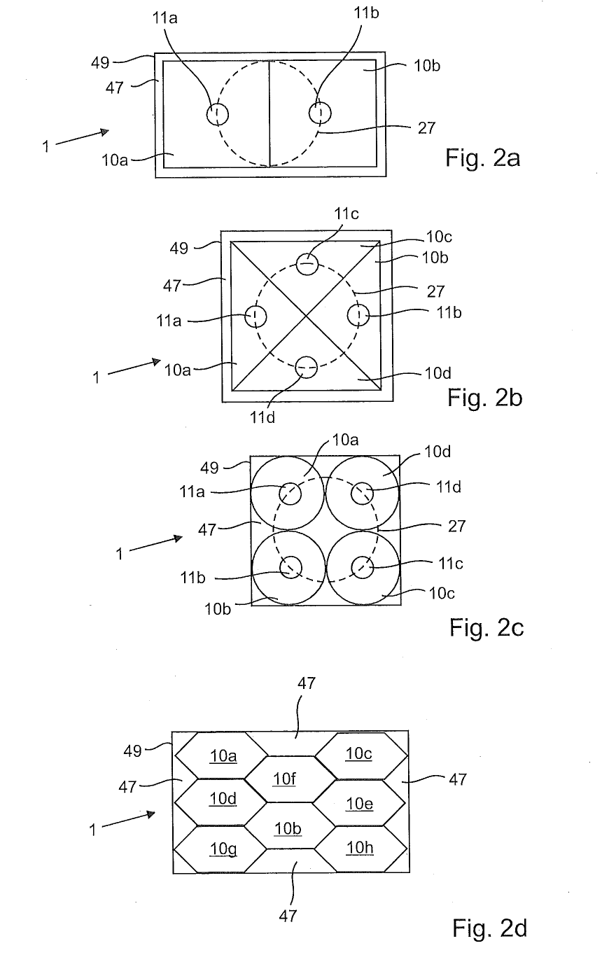

FIGS. 2a-2c show further arrangements of converter chambers 10 having converter chamber inlets 11 arranged on a circle 27, which may be used in combination with the above aerosol diverting device 16. The skilled person will realize, that the latter described aerosol diverting device 16 may be used in combination more than two converter chambers, depending on the size of the guiding element and the sizes of the respective inlet openings 11 of the converter chambers.

As mentioned above, the C-converter 1 comprises a plurality of converter chambers 10, i.e. at least two converter chambers 10. With respect to the converter chambers 10, the indices a, b, c, d and so on are used for referring to a particular converter chamber 10. The respective inlets, outlets, filters and other associated elements of the converter chambers 10 will also have the same indices a, b, c, d and so on (for example filter 13a, 13b, 13c). Furthermore, the indices a, b, c, d may be used for describing a specific switching sequence for delivering aerosol/gas to the plurality of converter chambers 10 during operation. In the position of the guiding element 23 of FIG. 3c, the converter chamber inlet 11a positioned on the left hand side is supplied with aerosol. The guiding element 23 is then rotated (switched) to supply aerosol to the converter chamber inlet 11b, positioned on the right hand side (see FIG. 3d). Subsequently, the guiding element 23 is again rotated to switch the supply of aerosol to the converter chamber inlet 11c positioned in the back. Finally the guiding element 23 is again rotated to switch the supply of aerosol to the converter chamber inlet 11d positioned in the front. This would complete a full switching sequence. In the next sequence, the guiding element 23 would again be rotated into the position of FIG. 3c.

The converter chamber inlets 11a-11d are converter chamber inlets 11 of a C-converter 1 having four converter chambers 10. Alternatively, the four converter chamber inlets 11a-11d could lead to two different C-converters, each having two converter chambers 10 (not shown). In such a case the converter chamber inlets 11a and 11c, shown in FIGS. 3c and 3d, could for example lead to the first and second converter chambers of a first C-converter, and the converter chamber inlets 11b and 11d, shown in FIGS. 3c and 3d, could lead to the converter chambers of a second C-converter.

Furthermore, it is considered that the outlet of the conduit 25 may be sized to cover more than one converter chamber inlet 11a-11d in each rotational position. The conduit 25 could for example supply aerosol to two converter chamber inlets 11 (11a and 11d in FIG. 3c) located adjacent in a rotational direction. After a 180° rotation of the rotatable guiding element 23, the outlet of the conduit would cover and supply two other converter chamber inlets 11 (11b and 11c in FIG. 3c). With such an arrangement (i.e. the outlet of the conduit 25 is sized to cover two adjacent converter chamber inlets 11) it is also contemplated to provide only a 90° rotation per switching event. In this case, the conduit 25 would for example first supply the two converter chamber inlets 11 (11a and 11d in FIG. 3c) located adjacent in a rotational direction with aerosol. After a rotation of 90° of the rotatable guiding element 23, one of the previously supplied converter chamber inlets such as 11d will continue to be supplied with aerosol, while the converter chamber inlet 11b, which is next in the rotational direction and was previously not supplied with aerosol, will now also be supplied with aerosol. As the skilled person will realize, each converter chamber inlet 11 will be supplied with aerosol for two consecutive switching event.

Generally, the gas diverting device 17 may be constructed similar to the above aerosol diverting device 16. However, it is considered to implement the gas diverting device 17 simply as an assembly of one or more gas valves, wherein the second gas (i.e. gas containing CO₂, H₂O steam) may be selectively supplied into the converter chambers 10 via the gas valves. In this way, a simple construction including standard hardware may be used.

The discharging device 18 is adapted to connect the converter chambers 10 (10a and 10b in FIG. 1) to the first converter outlet 7 (H₂ outlet for hydrogen) or with the converter outlet 9 (CO outlet for carbon monoxide CO or a CO/H₂ mixture (synthesis gas)). In FIG. 1, the converter chambers 10 each comprise two converter chamber outlets 14 and 15 (14a, 15a on the left hand side and 14b, 15b on the right hand side), wherein a first converter chamber outlet 14 (14a, 14b) is provided for discharging hydrogen and a second converter chamber outlet 15 (15a, 15b) is provided for discharging carbon monoxide. Although separate outlets 14, 15 are shown for the converter chambers 10, a single outlet may be provided in this configuration.

FIGS. 4 and 5 show examples of different configurations of diverting devices 16, 17, 18 and converter chambers 10. FIG. 4 shows an adaptation of the diverting device according to FIGS. 3a and 3b which is used as a discharging device 18. In FIG. 4, the discharging device 18 comprises two adjacent Y-tube configurations 19, 20, 21 according to FIGS. 3a and 3b, which, combined, form the discharging device 18. The upper converter chamber 10a is connected to an upper inlet tube 19a, and the lower converter chamber 10b is connected to the lower inlet tube 19b. The upper inlet tube 19a is connected either to the first upper branch tube 20a or to a second upper branch tube 21a, depending on the position of an upper (closing element) 22a (in the embodiment of FIG. 4 shown as a gate or flap valve). As an example, the first upper branch tube 20a will be used for discharging CO and leads to the second converter outlet 9. The second upper branch tube 21a may be used for discharging H₂ and leads to the first converter outlet 7. The lower converter chamber 10b is connected to a lower inlet tube 19b of the Y-tube arrangement. The lower inlet tube 19b is connected to first and second lower branch tubes 20b and 21b, which may selectively be connected to or disconnected from the lower inlet tube 19b by means of the lower shutter (closing element) 22b. Also in this case, the first lower branch tube 20b is used for discharging CO, and the branch tube 20b leads to the second converter outlet 9. The second lower branch tube 21 is also used for discharging H₂ and leads to the first converter outlet 7.

FIG. 5 shows an embodiment of the C-converter 1, wherein commercially available gas valves are used for implementing the gas diverting device 17 and the discharging device 18. The C-converter 1 of FIG. 5 comprises five converter chambers 10 (i.e. converter chambers 10a to 10e), having their respective inlets 11 arranged in a circular pattern. The aerosol diverting device 16 is connected to the aerosol converter inlet 3 and is implemented as a rotatable guiding element as described with reference to FIGS. 3c and 3d. The gas diverting device 17 is connected to the converter gas inlet 5 and comprises a gas distributor conduit 29 which is connected to the converter chambers 10 via a plurality of gas connector conduits 31. A gas inlet valve 33 is arranged in each gas connector conduit 31, wherein the gas inlet valve may connect the associated converter chamber 10 to the gas distributor conduit 29 and may disconnect the converter chamber 10 therefrom. If one or more of the first gas inlet valves 33 is/are open, gas from the converter gas inlet 5 may flow into the associated converter chamber 10. The gas will flow via the gas distributor conduit 29, through one of the gas connector conduits 31, and one of the gas inlet valves 33 into the respective converter chambers 10. The gas supplied into the converter gas inlet 5 may be gas containing CO₂ or H₂O steam, as mentioned above. Accordingly, the gas inlet valves 33 may also be called CO₂ valves or H₂O steam valves. It should be noted, that, aerosol and the gas may be supplied simultaneously into a plurality of the converter chambers 10, although not simultaneously into the same converter chamber. In other words, two or more of the converter chambers may be supplied with aerosol at one time. At the same time two or more other converter chambers may be supplied with the gas.

The discharging device 18 is constructed similar to the gas diverting device 17 and comprises a system of valves, connector conduits and distributor conduits. The discharging device 18 comprises an H₂ manifold 35 which is connected to the first converter outlet 7 for H₂. Furthermore, the discharging device 18 comprises a CO manifold 37, which is connected to the second converter outlet 9 for CO. The H₂ manifold 35 is connected to each one of the converter chambers 10 by means of a plurality of H₂ connector conduits 39. The CO manifold 37 is connected to each one of the converter chambers 10 by means a plurality of CO connector conduits 41. H₂ gas valves 43 are disposed in the H₂ connector conduits 39, and CO gas valves 45 are disposed in the CO connector conduits 41.

By means of the discharging device 18, each of the converter chambers 10 may be connected to the first converter outlet 7 and the second converter outlet 9 in an alternating manner. Particularly, any converter chamber 10 may be connected to or disconnected from the H₂ manifold 35 (leading to the converter outlet 7) by opening or closing, respectively, one or more of the respective H₂ gas valves 43. In the same way any converter chamber 10 may be connected to or disconnected from the CO manifold 37 (leading to the converter outlet 9) by opening and closing, respectively, one or more of the associated CO gas valves 45. It is noted that a plurality of converter chambers 10 may be simultaneously connected to the respective converter outlets 7 and 9, depending on the respective supply status. As mentioned above, the number of converter chambers 10 of the C-converter 1 is not limited to a particular number, and the shown configurations and numbers are merely examples.

During operation, the converter chamber 10 is typically held at a high temperature of several hundred degrees Celsius, preferably at a temperature of higher than 850° C. The desired temperature depends on the conversion reactions taking place inside the converter chambers 10, and the temperature is preferably higher than 850° C. when converting C and CO₂ into CO (the second gas from the converter gas inlet 5 is gas containing CO₂). Therefore, the converter chambers 10 are made of a heat resistant material, such as ceramics and/or metal. Furthermore, the filter 13 located inside the converter chambers 10 is made of a heat resistant material. The filter 13 may for example be a mesh filter or a ceramic filter. The converter chambers 10 may also comprise a porous ceramic base, which acts as a filter 13. Thus, the filter 13 may be separate from the housing of the converter chambers 10 or may be integrated therewith.

FIGS. 2a to 2d show different configurations and arrangements of converter chambers 10. The converter chambers 10 are generally tubular. Different cross sections of the tubes are possible, such as but not limited to rectangular (FIG. 2a), triangular (FIG. 2b), cylindrical (FIG. 2c) and hexagonal (FIG. 2d). The tubular converter chambers 10 are arranged side by side preferably with a close spacing such that a good heat transfer from one converter chamber 10 to an adjacent converter chamber 10 is achieved. In particular, the converter chambers are arranged in form of a tube bundle. The converter chambers 10 may consecutively be supplied with aerosol up to a desired maximum particle filling degree of the respective filter 13.

In all embodiments of FIGS. 2a to 2d, an optional shell 49 is disposed around the converter chambers 10. The shell 49 may for example be formed from a metal sheet and is in substance gas tight. Gaps 47 are formed between the shell 49 and the converter chambers 10a to 10d. The shell 49 may have at least one gas inlet and at least one gas outlet (not shown in the Figs.) such that a fluid (in particular gas containing CO₂, liquid H₂O or H₂O steam) may be passed through the gaps 47 during operation. If a fluid is directed through the gaps 47 during operation, the fluid will take up heat, which is radiated from the converter chambers 10. Preferably, the fluid is the second gas or a precursor thereof, which is preheated while being passed through the gaps 47 before being supplied to the respective converter chambers 10.

In the arrangement shown in FIG. 2a, the C-converter 1 comprises two converter chambers 10a, 10b which have a rectangular cross section. The rectangular converter chambers 10a, 10b abut on one side and, thus, provide mutual heat transfer. If the left converter chamber 10a is supplied with hot aerosol for the filtering step, while the right converter chamber is supplied with the second gas for the conversion (regenerating) step during operation of the C-converter 1, heat transfer to the right converter chamber 10b takes place. After switching the diverting devices 16, 17 the right converter chamber 10b is supplied with hot aerosol, and the left converter chamber is supplied with the second gas. Now, a heat transfer from the right converter chamber 10b to the left converter chamber 10a takes place. In the above and at least some of the following examples, it is assumed that the aerosol has a temperature which is higher than the conversion temperature and is used as the main source of heat for operating the C-converter. This may for example be the case, if the aerosol is the product of disassociating a hydrocarbon by means of a plasma or another source of thermal energy immediately before supplying the same to the respective converter chambers. Such a process may for example be performed in a Kvaerner reactor. It should be noted however, that other heat sources may be used.

FIG. 2b shows another embodiment of a C-converter 1 comprising four converter chambers 10a to 10d which are tubular and are arranged in parallel in a side by side configuration in form of a tube bundle. Here the chambers have a triangular cross section. Also in this case, a heat transfer to adjacent converter chambers takes place during operation. As an example, heat transfer from the converter chamber 10a to the adjacent converter chambers 10c and 10d occurs, if the first converter chamber 10a (on the left hand side in FIG. 2b) is supplied with hot aerosol. When the desired maximum particle filling degree of the converter chamber 10a is reached and the aerosol diverting device 16 is switched, the second converter chamber 10b on the opposing side (right hand side in FIG. 2b) is supplied with hot aerosol, and a heat transfer to the adjacent converter chambers 10c and 10d takes place. After another switching operation of the aerosol diverting device 16, the third converter chamber 10c is supplied with hot aerosol, and a heat transfer to the adjacent converter chambers 10a and 10b will take place. Finally, if the fourth converter chamber 10d is supplied with hot aerosol, a heat transfer to the adjacently located converter chambers 10a and 10b will take place.

FIG. 2c shows another arrangement of the converter chambers 10a to 10d of a C-converter 1, wherein the converter chambers 10a to 10d have a cylindrical tubular shape and are arranged in parallel in a side by side configuration in form of a tube bundle. Gaps 47 are formed between the cylindrical converter chambers 10a to 10d. A fluid may be directed through the gaps 47 between the converter chambers 10 and the gaps 47 between the converter chambers 10 and the shell 49. The fluid may take up heat which is given off by the converter chambers 10. In FIG. 2c, the supply of the aerosol into the converter chambers 10a to 10d is switched in a counterclockwise direction, i.e. from the first converter chamber 10a (left upper side) to the second converter chamber 10b (left lower side) to the third converter chamber 10c (right lower side) and to the fourth converter chamber 10d (right upper side). The converter chambers 10a to 10d may be filled subsequently in a clockwise direction or in a counterclockwise direction until the chambers are filled to the desired maximum particle filling degree, i.e. filling steps may take place in the sequence 10a, 10b, 10c and 10d, shown in FIG. 2c. The filling steps are in each case followed by a respective conversion step in each converter chamber. The second gas used in the conversion step ma be preheated before being supplied to the respective converter chambers by being passed through the gaps 47. Of course other sequences or operation are.

In FIGS. 2a to 2c, the converter chambers 10a to 10d (and/or their converter chamber inlets 11a to 11d for aerosol) are located on a respective circle 27. This circle 27 corresponds to the circle 27 shown in FIGS. 3c and 3d, and it will be obvious that the aerosol switching device 16 shown in FIGS. 3c and 3d may be used for switching the supply of aerosol between the converter chambers 10a to 10d.

FIG. 2d shows another embodiment of the C-converter 1 which comprises eight tubular converter chambers 10a to 10h, each comprising a hexagonal cross section. Again, the converter chambers 10a to 10h are arranged in parallel in a side by side configuration, such that heat transfer from one converter chamber 10 to an adjacent converter chamber 10 is achieved. The arrangement of the converter chambers 10a to 10h is also surrounded by a shell 49, similar to the one described above. Gaps 47 are formed between the shell 49 and the converter chambers 10a to 10h. Even though the converter chambers 10 are shown in FIG. 2d in such a way that the converter chambers abut, it should be noted that additional gaps 47 may be formed between the converter chambers 10, such as between the converter chambers 10b, 10d and 10f. The converter chambers 10a to 10h may also consecutively be supplied with aerosol until a maximum particle filling degree is reached. As an example, an aerosol diverting devices 16 working according to the principle shown in FIGS. 3a and 3b would be suitable for supplying an arrangement of converter chambers 10a to 10h as shown in FIG. 2d. The aerosol diverting devices 16 may be controlled during operation such that always at lest one converter chamber 10 is supplied with hot aerosol, which is located near comparatively colder converter chambers 10. The comparatively colder converter chambers 10 may be converter chambers 10 which are currently being regenerated or have been supplied with aerosol some time ago. Thus, the thermal energy of the hot aerosol may be well utilized. One exemplary sequential pattern for supplying the converter chambers shown in FIG. 2d would be 10a, 10b, 10c, 10d, 10e, 10f, 10g, 10h. Also in the embodiment of FIG. 2d, the second gas (gas containing CO₂, H₂O steam) may be directed through the gaps 47 such that the second gas may be preheated before it is directed into the respective converter chambers 10a to 10h.

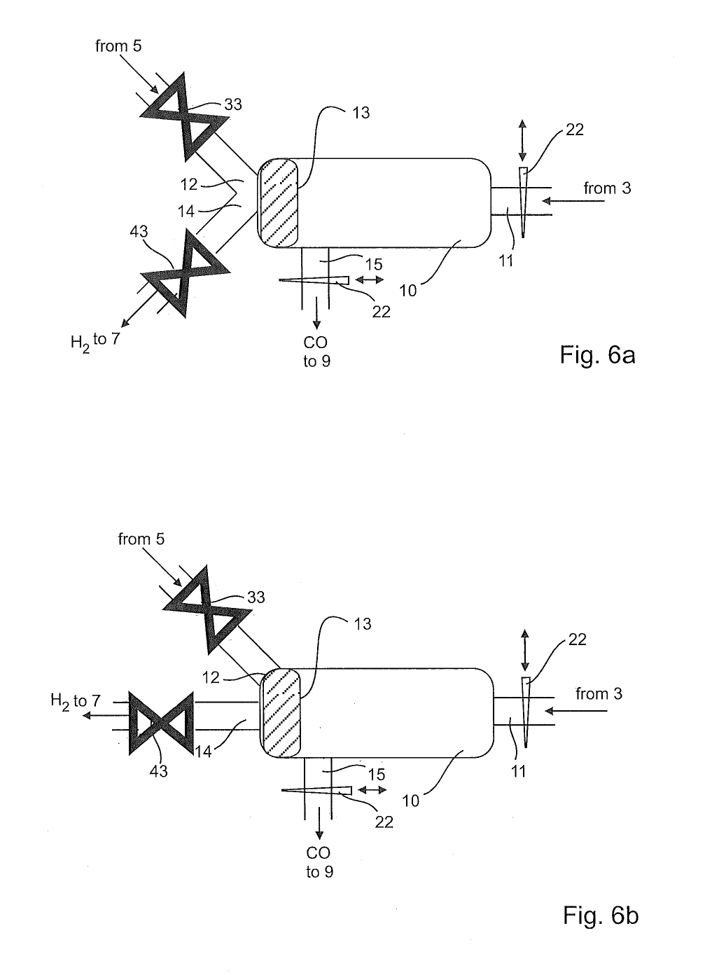

FIG. 6a shows an arrangement of the converter chamber inlets 11, 12 and the converter chamber outlets 14, 15 of one converter chamber 10. An aerosol may be supplied from the aerosol converter inlet 3 via the first converter chamber inlet 11. By means of a shutter (closing element) 22, supplying of aerosol may be admitted or blocked. A second gas (gas containing CO₂, H₂O steam) may be supplied into the converter chamber 10 via the second converter chamber inlet 12. Supplying the second gas may for example be controlled by means of a gas inlet valve 33. The converter chamber 10 also comprises a first converter chamber outlet 14 which is located in flow direction of the aerosol downstream of the filter 13. The first converter chamber outlet 14 is always open when the aerosol is supplied and closed when the second gas is supplied. When aerosol is supplied into the first converter chamber inlet 11, the filter 13 traps the particles containing carbon from the aerosol. The H₂ gas contained in the aerosol, passes through the filter 13, and is discharged through the first converter chamber outlet 14. The first converter chamber outlet 14 may be opened or closed by means of a H₂ gas valve 43. This is similar to the previous embodiments.

In the embodiment of FIG. 6a, the second converter chamber inlet 12 and the first converter chamber outlet 14, however, are close to each other or may be congruent. They are arranged on the same side with respect to the filter, which is different to the previous examples, where they were arranged on opposite sides of the filter 13. The converter chamber 10 also comprises a second converter chamber outlet 15 which is located in a flow direction of the aerosol upstream of the filter 13. In other words, the second converter chamber outlet 15 is connected to an interior space of the converter chamber 10 which extends between the converter chamber inlet 11 and the filter 13. In particular, the second converter chamber outlet is arranged on an opposite side of the filter with respect to the second converter chamber inlet 12. The second converter chamber outlet 15 may be opened or closed via a shutter 22 or via a CO gas valve 45 (not shown in FIG. 6a). The second converter chamber outlet 15 is controlled to be closed when an aerosol is supplied via the first converter chamber inlet 11 and to be open when the second gas is supplied via the second converter chamber inlet 12.

The second converter chamber inlet 12 is located such that a gas supplied thereby may pass through the filter 13 in a flow direction opposite to the flow direction of the aerosol. When supplying the aerosol, a filter cake, is formed by the particles containing carbon, which are trapped in the filter. When the second gas is supplied, the filter cake will be detached from the filter 13 by passing the second gas through the filter in a direction of flow opposite to the direction of flow of the aerosol. This reverse flow may lead to an improved detachment of particles and thus good reactivity of the particles with the second gas will be ensured. A respective converter chamber may thus be regenerated faster.

Depending on the size of the particles containing carbon, a secondary aerosol comprising the second gas and the particles containing carbon may exit from the converter chamber outlet 15. In other words it is possible that the conversion of detached particles is not complete before the particles exit via the second converter chamber outlet 15. However it is contemplated that such particles may be present only over a short distance, in a respective conduit (not shown) connected to the second converter chamber outlet 15. However, such secondary aerosol including the second gas and the particles containing carbon will likely be converted completely into CO in such a conduit. Depending on the type of second gas, the secondary aerosol will comprise CO₂ , particles containing carbon and CO (if the second gas contains CO₂) or H₂O steam, particles containing carbon, H₂ and CO (if H₂O steam is supplied as the second gas).

FIG. 6b shows a similar arrangement of a converter chamber 10 having two converter chamber inlets 11 and 12 as well as two converter chamber outlets 14 and 15. In the embodiment of FIG. 6b the second converter chamber inlet 12 and the first converter chamber outlet 14 are not coincident, different from FIG. 6a. Otherwise, the structure of the embodiment of FIG. 6b is similar to the embodiment of FIG. 6a. In particular, the aerosol converter inlet 11 and the second converter chamber outlet 15 are arranged on one side of the filter 13 and the second converter chamber inlet 12 and the second converter chamber outlet 14 are arranged on the other side of the filter 13. Furthermore, movement of respective shutters or diverting elements is controlled such that always only one of the inlets 11, 12 and the respective outlet 14, 15 are open at the same time. When the aerosol converter chamber inlet 11 is open, the first converter chamber outlet 14 is open, while the second converter chamber inlet 12 and the second converter chamber outlet 15 is blocked. Similarly, when the second converter chamber inlet 12 is open, the second converter chamber outlet 15 is open and the aerosol converter chamber inlet 11 and the first converter chamber outlet 14 are blocked. This ensures that any media flow through the converter chamber 10 passes through the filter 13. Upon reaching the desired maximum particle filling degree of a converter chamber 10, i.e. after ending the supply of aerosol into the converter chamber 10, the second gas will be blown through the filter 13 in a direction opposite to the flow direction of the aerosol, whereby the trapped particles containing carbon are released from the filter 13. Again, an aerosol consisting of particles containing carbon and the second gas may be present over a short flow distance outside of the converter chamber 10. However, also in this case, a complete conversion into CO will taken place downstream of the converter chamber outlet 15.

Operation of the C-converter 1 will be described with reference to FIG. 1 for a case where gas containing CO₂ is supplied through the converter gas inlet 5 as a second gas.

At first, the first converter chamber 10a will be supplied with aerosol comprising particles containing carbon (C-particles) and hydrogen H₂ via the aerosol converter inlet 3 and the aerosol diverting device 16. The aerosol is produced by a hydrocarbon converter which operates with thermal energy or plasma, preferably a Kvaerner-reactor. In the described example, the aerosol coming from the hydrocarbon converter has a high temperature of for example 1200 to 1800° C., as the hydrocarbon converter is of the type which operates with a high temperature plasma. In other examples, where the aerosol is delivered from an aerosol storage container or where the hydrocarbon converter is operating with low thermal energy or with a low temperature plasma, the aerosol may have a temperature of below 850° C. (but typically of at least 300° C.). If the aerosol is directed into the C-converter 1 at a temperature of less than 850° C. the aerosol will be heated to a temperature of more than 850° C. prior to supplying into the converter chambers 10 or will be heated inside the converter chambers 10. Suitable heaters may be provided either for heating the ductwork leading to the converter chambers 10 or for heating the converter chambers 10 or at least parts thereof. In the following description, as indicated above, the aerosol is considered to come from a high temperature hydrocarbon converter.

The aerosol consisting of hot particles containing carbon (C-particles) and hot H₂ gas, flows into the first converter chamber 10a and heats the converter chamber. The hot particles containing carbon are trapped by the filter 13a of the first converter chamber 10a. The longer the aerosol is supplied into the first converter chamber 10a the more particles containing carbon will deposit in the filter 13a until a desired maximum particle filling degree is reached. The first converter chamber outlet 14 is open and H₂ which freely passes through the filter 13 is directed to the first converter outlet 7 for H₂ via the discharging device 18.

The desired maximum particle filling degree may for example be determined based on a pressure difference across the converter chamber 10, based on an increase in weight of the converter chamber 10 or by means of another measurement. The particle filling degree may for example be determined by means of an optical sensor, which recognizes a filling height, by means of an ultrasonic sensor or by means of similar known sensors. Alternatively, the particle filling degree may be determined by using a high frequency sensor which senses variation of high frequency signals which are directed through a converter chamber 10 wherein the characteristics thereof change depending on the particle filling degree of the converter chamber 10. The desired maximum particle filling degree may also be defined based on a predetermined cycle time of switching between filling and regenerating the converter chambers 10.

When the desired maximum or predetermined filling degree of the first converter chamber 10a has been reached, the aerosol diverting device 16 switches and supplies the second converter chamber 10b with aerosol. Due to the supply of hot aerosol, the second converter chamber 10b will be heated in the same way, and the filter 13b of the second converter chamber 10b will accumulate particles containing carbon over time up to a desired maximum particle filling degree.

After switching the aerosol supply to the second converter chamber 10b, the second gas, i.e. gas containing CO₂, is supplied into the previously filled first converter chamber 10a for regeneration. The gas containing CO₂ is supplied from the converter gas inlet 5 and via the gas diverting device 17, for example via the gas inlet valves 33 shown in FIGS. 5, 6a and 6b. The gas containing CO₂ may be supplied to one side of the filter 13a, as shown in FIGS. 6a and 6b, such that the gas containing CO₂ is flowing in a direction opposite to the flow direction of the aerosol through the filter 13a. This counter flow may enhance detachment of the particles containing carbon previously trapped in the filter 13a. It is, however, also possible to supply the second gas in the same direction as the aerosol, and pass it through the filter 13 in the same direction as the aerosol. Also this flow of gas may lead to detachment of the particles. The detached particles provide for a large reactive surface providing a fast and complete reaction of the particles containing carbon and the gas containing CO₂. If necessary, the supplied gas containing CO₂ may be preheated, and the gas has a temperature of 300 to 1000° C., preferably about 600 to 900° C., when supplied into the converter chamber 10a. The converter chamber 10a has a temperature of more than 850° C. during regeneration by the gas containing CO₂. The particles containing carbon (C-particles) are converted together with CO₂ into carbon monoxide CO according to the equation C+CO₂→2CO, without utilizing catalysts.

The carbon monoxide CO generated in the converter chamber 10a will be discharged from the converter chamber 10a and is directed to the second converter outlet 9 for carbon monoxide CO via the discharging device 18. Discharging may for example take place via the above mentioned connector conduits 41 and the manifold 37 (see FIG. 5).

The gas containing CO₂ is supplied into the corresponding converter chamber 10 to be regenerated until the converter chamber reaches a desired minimum particle filling degree. The desired minimum particle filling degree may be 0%, however does not have to be 0%, since it is not always economically viable to completely convert the C-particles into CO during operation. The desired minimum particle filling degree may be determined based on a predetermined cycle time of switching between filling and regenerating the converter chambers 10. Alternatively, the desired minimum particle filling degree may be determined based on a sensor output, for example based on a pressure drop, based on a decrease in weight and so on. The measurements for the desired maximum and minimum particle filling degree may be obtained by means of the same sensors and devices mentioned above.

Furthermore, supplying the aerosol (filtering or filling) and supplying the second gas (regenerating) into a converter chamber 10 may be switched based on the fact that another converter chamber 10 has reached a desired minimum or maximum particle filling degree. As an example, if one of the converter chambers 10 currently supplied with gas containing CO₂ has already been regenerated to the desired minimum particle filling degree, the supply of aerosol may already be switched to the regenerated converter chamber 10 before another currently supplied converter chamber 10 has reached its desired maximum particle filling degree. If a currently supplied converter chamber is filled to the desired maximum particle filling degree and cannot be filled any more, switching the supply of aerosol to a next converter chamber may be carried out.

In all embodiments, the amount and the size of the converter chambers 10 is chosen in such a way that the C-converter 1 may be continuously supplied with aerosol. The switching operations for sequentially supplying one or more of the converter chambers 10 with aerosol are carried out based on the filling degree of the converter chambers 10 and the supplied volume of the aerosol per time period. As mentioned above, also a plurality of converter chambers 10 may simultaneously be supplied with aerosol. Also a plurality of converter chambers 10 may simultaneously be supplied with gas containing CO₂ and, thus, may simultaneously be regenerated. As an example, two converter chambers 10 (for example 10a and 10b in FIG. 2b or 2c) may simultaneously be supplied with aerosol, while two other converter chambers 10 (for example 10c and 10d in FIG. 2b or 2c) are regenerated by supplying the gas containing CO₂.

The time during which a converter chamber 10 is filled until reaching the maximum particle filling degree does not necessarily have to correspond to the time during which a converter chamber filled to the maximum is regenerated by feeding the gas containing CO₂. As an example, a situation will be described wherein the regeneration of a converter chamber 10 by feeding gas containing CO₂ takes twice the time as filling the converter chamber 10 up to a maximum particle filling degree. In such a situation, the C-converter 1 has for example three converter chambers 10a, 10b, 10c. Lets consider that the first converter chamber 10a has just been filled with aerosol and that the gas containing CO₂ is currently supplied into the first converter chamber 10a. The first converter chamber 10a may now be regenerated over two time periods (for example two minutes) by supplying gas containing CO₂. At the same time the second converter chamber 10b (during the first time period) and then the third converter chamber 10c (during the second time period) will be supplied with aerosol. When the two other converter chambers 10b and 10c have been filled with aerosol and have reached the respective desired maximum particle filling degree, their respective regeneration begins by supplying the gas containing CO₂. That means, that regeneration of the second converter chamber 10b begins at the beginning of the second time period, and regeneration of the third converter chamber 10c begins following the second time period (the beginning of a third time period). Since regenerating the first converter chamber 10a takes two time periods (for example two minutes), the other two converter chambers 10b and 10c could be filled up to the desired maximum particle filling degree during said regeneration time (i.e. two converter chambers having each a filling time of one time period). Since the first converter chamber 10a is sufficiently regenerated after supplying the gas containing CO₂ for two minutes and therefore comprises the desired minimum particle filling degree, the aerosol diverting device 16 switches again to the first converter chamber 10a and begins to fill the first converter chamber. At this point in time, the second converter chamber 10b is half regenerated, and regeneration of the third converter chamber 10c has just begun.

The operation described above also works if several converter chambers 10 are simultaneously supplied. Instead of the above described three converter chambers 10 (for a regeneration time which is twice compared to the filling time) also six converter chambers 10 may be provided, wherein two converter chambers 10, respectively, are simultaneously filled with aerosol. In this case, two converter chambers 10 will switch as a pair at each switching step between supply with aerosol or supply with the second gas. If several converter chambers 10 are filled simultaneously, these numbers multiply.

The above described example wherein the regeneration takes twice the time is an arbitrary example. Structure and operation may be adapted to other timings, as will be obvious to the skilled person. As an example, four converter chambers 10 may be provided if the regeneration time is triple the filling time, or five converter chambers 10 may be provided if the regeneration time is quadruple the filling time. If two or more converter chambers 10 are concurrently filled or regenerated, the above mentioned numbers double or multiply. The skilled person will choose the amount and capacity of the converter chambers based on the time periods which are actually to be expected during operation. Although continuous operation of the converter chamber is most desired, both the filling and the regeneration may be discontinuous, i.e. intermittent. When used in combination with a hydrocarbon converter which continuously supplies the aerosol, it is beneficial if at least the filling operation is continuous, i.e. at least one chamber is always being filled. The regeneration on the other hand may be discontinuous, i.e. there may be periods in time, where no chamber is currently regenerated. While CO₂ or water/water vapor may be easily stored or buffered, the aerosol cannot be stored quite as easily.

As was described above, the converter chambers 10 are arranged side by side such that the converter chambers may heat each other by their waste heat. The second gas (gas containing CO₂, H₂O steam) or another fluid may be directed through the gaps 47 between the converter chambers 10 and/or between the converter chambers 10 and the shell 49 (FIGS. 2a-2d and others). In the present embodiments, the gas containing CO₂, may be produced by an industrial apparatus, such as but not limited to a blast furnace, a power plant or a combustion machine, and has a temperature of more than 200° C. resulting from said industrial apparatus. When the gas containing CO₂ is directed through the gaps 47, the gas containing CO₂is further heated by the waste heat from the converter chambers 10 such that the gas is directed into the converter chambers 10 at a temperature of between 600° C. to 1000° C.

If the second gas is H₂O steam, the structure of the C-converter 1 is the same as described above. The difference is that H₂O steam is supplied via the converter gas inlet 5 instead of a gas containing CO₂. In this case, the carbon of the particles containing carbon will be converted into carbon monoxide and hydrogen according to the equation C+H₂O→CO+H₂. Accordingly, in this case a gaseous carbon monoxide/hydrogen mixture is produced in the converter chambers 10, and said mixture exits from the C-converter outlet 9.

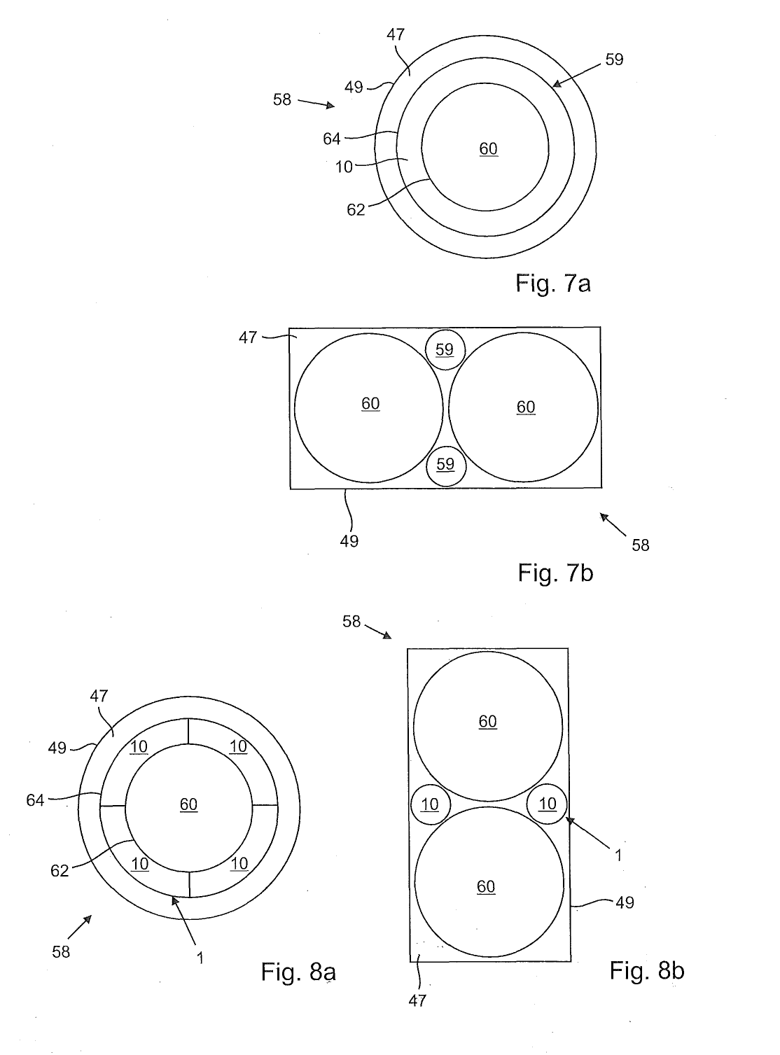

In the following, an apparatus 58 for producing carbon monoxide CO is described. The apparatus 58 comprises a C-converter 59 as well as a hydrocarbon converter 60 operated with plasma or with thermal energy, preferably a Kvaerner-reactor. In a basic embodiment, the hydrocarbon converter 60 is cylindrical and has a circular cross section, as shown in FIG. 7a, which shows a cross section as seen along the cylinder axis of the hydrocarbon converter 60. The hydrocarbon converter 60 has an outer casing 82 which encloses and protects the hydrocarbon converter, in the hydrocarbon converter 60 a fluid containing hydrocarbons is decomposed under exposure to thermal energy or plasma at high temperatures. The fluid containing hydrocarbons may be a gas, such as natural gas, but may also be a liquid, such as petroleum or other fluids and gases containing hydrocarbons or may be an aerosol containing hydrocarbons. In the hydrocarbon converter 60, high temperatures prevail, which may be transferred through the outer casing 62 to the surroundings. In the case of a high temperature Kvaerner-reactor, temperatures of 1700° C. may be present in the interior thereof.

The C-converter 59 comprises an encasement 64 which surrounds the outer casing 62 of the hydrocarbon converter 60. The outer casing 62 of the hydrocarbon converter 60 and the encasement 64 of the C-converter 59 form an annular space which serves as converter chamber 10 of the C-converter 59. In FIG. 7a, the C-converter 59 has a cylindrical tubular form but may alternatively have another form which is adapted to the shape of the outer casing 62. In the C-converter 59, particles containing carbon, such as pure carbon or carbon black, respectively, may be converted in presence of carbon dioxide CO₂ or a gas mixture containing CO₂ or H₂O steam as a second gas into carbon monoxide CO at temperatures above 850° C.

Since the C-converter 59 is concentrically arranged with respect to the outer casing 62 of the hydrocarbon converter 60, the waste heat from the hydrocarbon converter 60, which is radiated from the outer casing 62, will be transferred to the C-converter 59. Thus, it is possible to operate the C-converter 59 at the desired high temperatures of more than 850° C. without the need for an additional dedicated heating device or if at all a heating device which may have low power.

As shown in FIG. 7a, the encasement 64 of the C-converter is optionally surrounded by a shell 49. The shell 49 and the encasement 64 form an annular gap 47. The shell 49 and the gap 47 have the same function as previously described with respect to FIGS. 2a-2d. A fluid, such as water or a coolant may be directed through the gap 47. By means of the shell 49 and the gaps 47, the second gas (gas containing CO_{2,} H₂O steam) to be supplied into the C-converter 59 may be preheated, wherein said second gas is used for conversion inside the C-converter 59 during operation. The second gas will be directed through the gap 47 and absorbs the waste heat from the C-converter 59, which is given off by the encasement 64. Alternatively, water in liquid form may be injected into the gap 47, where the water is converted into steam at the high temperatures near the converter chamber 10 and thus forms H₂O steam.

FIG. 7b shows another embodiment of the apparatus 58 for producing CO (in cross section seen along the cylinder axis of the hydrocarbon converter 60). The apparatus 58 for producing CO comprises two tubular C-converters 59 having a cylindrical cross section and two cylindrical hydrocarbon converters 60. The hydrocarbon converters 60 are arranged side by side such that their cylindrical outer casings 62 are located in close proximity. The C-converter 59 is located with a small distance relative to the outer casing 62 of the hydrocarbon converter 60 such that heat transfer from the hydrocarbon converter 60 to the C-converter 59 is achieved. The C-converter 59 is located at a position where the outer casings 62 of the hydrocarbon converters 50, due to their circular shape, form a gap for locating the tubular C-converter 59 is formed (see FIG. 7b). The arrangement of the two hydrocarbon converters 60 and the two C-converters 59 is surrounded by a shell 49. Thus, gaps 47 are formed between the hydrocarbon converters 60 and the C-converters 59 as well as between the hydrocarbon converters 60, the C-converters 59 and the shell 49. Just as in the embodiment of FIG. 7a, a fluid may be directed through the gap 47, particularly, the second gas (gas containing CO_{2,} H₂O steam) and the fluid may be preheated by the waste heat of the hydrocarbon converter 60 and the C-converter 59.

The apparatus 58 for producing CO preferably comprises the above described C-converter 1, which comprises a plurality of converter chambers 10. FIG. 8a shows an embodiment of the apparatus 58 for producing CO similar to the one shown in FIG. 7a, which comprises a C-converter 1 according to the above description, where the C-converter 1 comprises four converter chambers 10. FIG. 8b shows an embodiment of the apparatus 58 for producing CO shown in FIG. 7b, which comprises a C-converter 1 according to the above description, where the C-converter 1 comprises two converter chambers 10. The diverting devices 16, 17 for supplying aerosol and the second gas and the discharging device 18 for discharging the end products of the filtering and the conversion (regeneration) are not shown in FIGS. 8a and 8b. Like FIGS. 7a and 7b, FIGS. 8a and 8b show a cross section as seen along the cylinder axis of the hydrocarbon converter 60.

In the embodiments of FIGS. 7a and 8a, the arrangement of the gaps 47 and C-converter 1, 59 may also be reversed, i.e. the gaps 47 are located radially between the C-converter 1, 59 and the hydrocarbon converter 60. However, the embodiment described above is preferred since it allows a more economical operation.

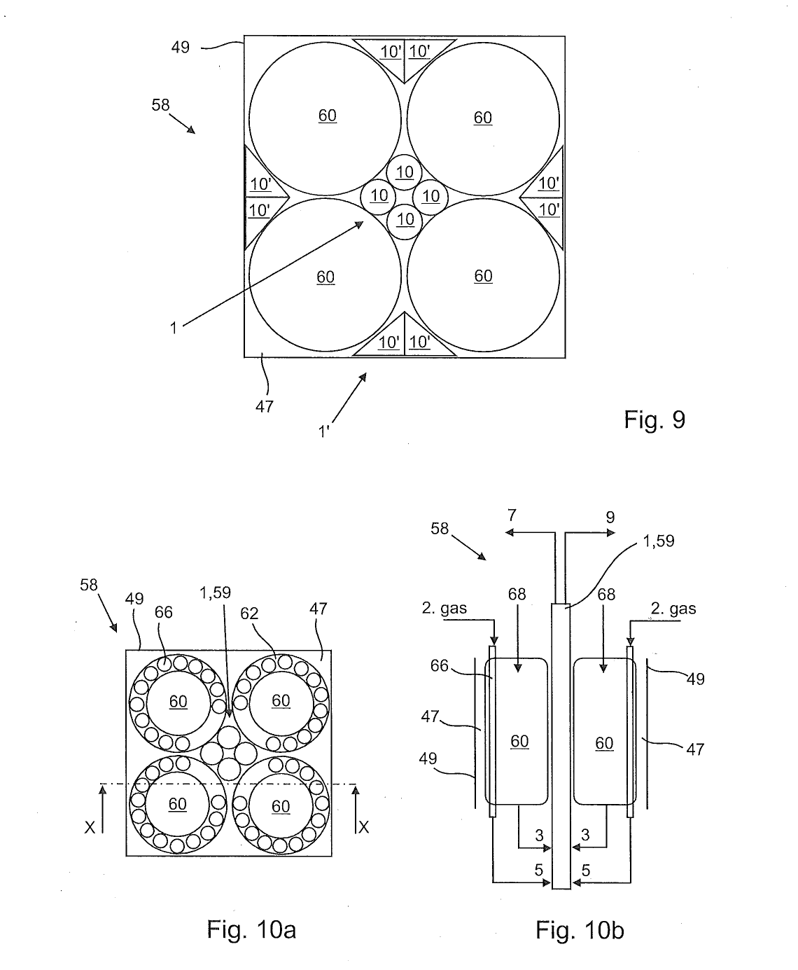

FIG. 9 shows an embodiment of the apparatus 58 for producing CO which comprises five C-converters 1, 1′ and four hydrocarbon converters 60 (shown in cross section in a viewing direction along the cylinder axis of the hydrocarbon converter 60). The arrangement of the C-converters 1, 1′ and the hydrocarbon converter 60 is surrounded by a shell 49. Each of the hydrocarbon converters 60 comprises a cylindrical outer casing 62. The hydrocarbon converters 60 are arranged such that the cylindrical outer casings 62 are arranged in close proximity. Gaps 47 are formed between the hydrocarbon converters 60 and between the hydrocarbon converters 60 and the shell 49 due to the cylindrical shape of the outer casings 62. The C-converters 1, 1′ are located in the gaps 47. The C-converters 1, 1′ are tubular, are arranged as a tube bundle and have different cross sections, as shown in FIG. 9.

A first embodiment of the C-converter 1 is disposed in a gap in the center between the cylindrical hydrocarbon converters 60. The C-converter 1 located in the center comprises four converter chambers 10, wherein each converter chamber is cylindrical and wherein the converter chambers are disposed as a tube bundle near to the corresponding outer casing 62 of the four hydrocarbon converters 60.

A second style of C-converters 1′ is disposed in a gap between the shell 49 and the cylindrical outer casing 62 of two adjacent hydrocarbon converters 60, respectively. The second style of C-converters 1′ comprises two tubular converter chambers 10′ having a triangular cross section and being arranged as a tube bundle next to each other and near to the outer casings 62. The gaps 47 act as conduits for a fluid, particularly for the second gas (gas containing CO₂, H₂O steam).

As explained above, the hydrocarbon converters 60 produce hot aerosol comprising hydrogen H₂ and particles containing carbon during operation, wherein the aerosol is alternately supplied to the converter chambers 10, 10′ of the C-converters 1, 1′ via one or more aerosol diverting devices 16 (not shown in FIG. 9). The second gas is directed through the gaps 47, wherein the second gas is heated by the waste heat from the hydrocarbon converters 60 and the converter chambers 10, 10′. As soon as one of the converter chambers 10, 10′ is to be regenerated, the supply of hot aerosol is stopped, and the heated second gas will be directed into the converter chambers 10, 10′ to be regenerated. During regeneration, the carbon (C) of the particles containing carbon, together with the second gas, is converted either in CO (according to the equation C+CO₂→2CO) or into a CO/H₂ mixture (according to the equation C+H₂O→CO+H₂).

While the apparatus for producing CO was described with reference to FIG. 9 in such a way that the apparatus comprises five C-converters 1, 1′, it should be noted that the grouping of the chambers shown in FIG. 9 is arbitrary and the cambers may be differently grouped to form a C-converter 1, 1′. As an example, the four converter chambers 10 located in the middle could belong to a first C-converter 1, and the eight outer converter chambers 10′ having a triangular tube cross section could belong to a single second C-converter 1′.

The C-converters 1, 1′ shown in FIG. 9 could be supplied with aerosol from all hydrocarbon converters 60 in combination or from individual hydrocarbon converters 60. That means, that the aerosol produced by the hydrocarbon converters 60 may be first mixed and then diverted to the converter chambers 10, 10′, or the aerosol from one or more specific hydrocarbon converters 60 could be directed to one or more specific converter chambers 10, 10′. In FIG. 9, three hydrocarbon converters 60 could provide the aerosol for the outer C-converters 1′ having converter chambers 10′ having triangular cross section, while one hydrocarbon converter 60 could provide the aerosol for the C-converter 1 located in the middle having the cylindrical converter chamber 10.

FIGS. 10a and 10b show another embodiment of the apparatus 58 for producing CO. FIG. 10a shows another apparatus 58 for producing CO (in cross section as seen along the cylinder axis of the hydrocarbon converters 60), and FIG. 10b shows a sectional view of the apparatus 58 as seen along line X-X of FIG. 10a. The apparatus 58 of FIGS. 10a and 10b comprises four hydrocarbon converters 60 and one C-converter 1 (having four converter chambers) or four C-converters 59. As described in the other examples, the apparatus 58 comprises a shell 49. The shell 49 and the hydrocarbon converters 60 and the C-converters in combination form a plurality of gaps 47 for passing a fluid therethrough.

The hydrocarbon converters 60 also have an outer casing 62, having a plurality of fluid conduits 66 located therein. An inlet and an outlet (not shown) for the fluid conduits 66 are provided to enable a fluid to be directed through the fluid conduits 66. The fluid conduits 66 may be arranged in any desirable pattern in the outer casing 62 so as to achieve a good heat transfer of waste heat to the fluid. The pattern may for example be straight, in serpentines, spirally around the outer casings 62 and so on. If the fluid is the second gas (CO₂, H₂O steam), it is preheated by the waste heat of the corresponding hydrocarbon converter 66. As shown in FIG. 10a, the outer casing 62 of each hydrocarbon converter 60 is free from fluid conduits 66 in a region adjacent the C-converter 1 so as to improve heat transfer from the hydrocarbon converter 60 to the C-converter 1.

As best seen in FIG. 10b, a fluid containing hydrocarbons (for example natural gas, petroleum, aerosols containing hydrocarbons) is supplied into the hydrocarbon converter 60 through a hydrocarbon inlet 68 during operation. In the hydrocarbon converter 60, the fluid containing hydrocarbons is decomposed into C and H₂ under the influence of thermal energy or plasma. The components C and H₂ form an aerosol which is directed into the C-converter 1 via an aerosol converter inlet 3. Furthermore, a second gas is first directed through the fluid conduits 66 and is heated therein by the waste heat of the corresponding hydrocarbon converter 60. The heated second gas is directed into the C-converter 1 via the converter gas inlet 5. Inside the C-converter 1, the aerosol and the second gas are filtered and converted, respectively according to the method of operating the C-converter 1 as described above. Hydrogen gas (H₂), which was separated from the particles containing carbon in the aerosol via the filter 13 of the C-converter 1, is discharged from the converter outlet 7. Carbon monoxide (CO) produced in the C-converter (second gas is gas containing CO₂) or a CO/H₂ mixture (second gas is H₂O steam) is discharged from the second converter outlet 9.

In all embodiments of the apparatus 58, the conduits and gaps 47 are constructed in such a way that good heat transfer is obtained. In all embodiments of the apparatus 58, the pressure, the flow rate and other characteristics of the fluids directed therethrough are chosen during operation such that a good heat transfer and a good energy transfer is obtained. The pressure, the flow rate and other characteristics of the fluids directed therethrough are also controlled to enable good filtering and regeneration in the respective converter chambers. In particular, the flow rate and temperatures of the aerosols and the second gas are matched to allow filtering and regenerating steps to be completed at desired time intervals. As described above, the desired time intervals may be equal but may also differ from each other.

The invention has been described with reference to preferred embodiments, wherein the individual features of the described embodiments may be unrestrictedly combined and/or exchanged as long as these features are compatible. Also individual features of the described embodiments may be omitted, as long as these features are not essential. For the skilled person numerous variations and other embodiments would be possible and obvious without leaving the scope of the invention.

1-29. (canceled)

30. A C-converter (1) comprising:
at least one aerosol converter inlet (3) for an aerosol comprising a first gas and particles containing carbon, wherein the first gas is hydrogen;
at least one converter gas inlet (5) for a second gas connected to a supply for a second gas comprising H₂O or exhaust gas containing CO₂;
at least two converter outlets (7, 9);
at least two converter chambers (10) each comprising at least one filter (13) adapted to filter particles containing carbon from the aerosol;
at least one diverting device (16, 17) adapted to alternately connect a fraction of the at least two converter chambers (10)
a) with at least one aerosol converter inlet (3) or
b) with at least one converter gas inlet (5);
at least one discharging device (18) adapted to alternately connect a fraction of the at least two converter chambers (10) with at least one of the converter outlets (7, 9); and wherein the at least one aerosol converter inlet (3) is connected to at least one hydrocarbon converter (60) adapted to operate with plasma and adapted to decompose fluids containing hydrocarbons into an aerosol comprising carbon particles and hydrogen.

31. The C-converter (1) according to claim 30, wherein the filter (13) is a heat resistant mesh filter or a ceramic filter.

32. The C-converter (1) according to claim 30, wherein the converter chambers (10) comprise a porous ceramic base as a filter (13) and a ceramic shell.

33. The C-converter (1) according to claim 30, wherein the converter chambers (10) are arranged side by side, to facilitate a heat transfer from one converter chamber (10a) to an adjacent converter chamber (10b).

34. The C-converter (1) according to claim 30, wherein the converter chambers (10) are tubular, extend parallel and are arranged side by side as a tube bundle, and wherein the tubular shape has a cylindrical, triangular, rectangular or hexagonal cross section.

35. The C-converter (1) according to claim 33, wherein gaps (47) are formed between the converter chambers (10), and wherein the gaps (47) are connected with an inlet and an outlet, which allow passing a fluid through the gaps (47).

36. The C-converter (1) according to claim 30, wherein the diverting device (16, 17) comprises at least one aerosol diverting device (16) and at least one gas diverting device (17).

37. The C-converter (1) according to claim 30, wherein each of the converter chambers (10) comprises at least one converter chamber inlet (11, 12), wherein at least a fraction of the converter chamber inlets (11) of the at least two converter chambers (10) is located on a circle (27), and wherein at least one diverting device (16, 17) comprises a rotatable diverting element (23) adapted to connected the aerosol converter inlet with at least one of the converter chamber inlets (11) located on the circle (27).

38. The C-converter (1) according to claim 30, wherein each of the converter chambers (10) comprises at least one converter chamber outlet (14, 15), wherein the discharging device (18) comprises a valve assembly having at least one valve (43, 45) for each converter chamber (10), wherein the valve assembly is adapted to alternately connect at least one of the converter chamber outlets (14, 15) with
a) the first converter outlet (7) or
b) the second converter outlet (9).

39. An apparatus (58) for producing CO or synthesis gas, comprising:
at least one hydrocarbon converter operated with plasma, the hydrocarbon converter (60) having an outer casing (62) and being adapted to decompose fluids containing hydrocarbons into carbon and hydrogen; and
at least one C-converter (1, 1′) according to claim 30;
wherein the C-converter (1, 1′) is disposed adjacent to the outer casing (62) of the hydrocarbon converter (60) so as to facilitate a heat transfer from the hydrocarbon converter (60) to the C-converter (1, 1′).

40. The apparatus (58) according to claim 39, comprising a plurality of hydrocarbon converters (60) arranged side by side, wherein at least one gap (47) is formed between the hydrocarbon converters, wherein one or more converter chambers of at least one C-converter (1, 1′) is/are disposed in the least one gap (47).

41. The apparatus (58) according to claim 39, wherein the C-converter (1, 1′) partially or completely surrounds the hydrocarbon converter (60) along its circumference.

42. The apparatus (58) according to claim 41, wherein the C-converter concentrically surrounds the outer casing (62) of the hydrocarbon converter (60).

43. The apparatus (58) according to claim 39, wherein fluid conduits (66) are disposed on or in the outer casing (62) of the hydrocarbon converter (60).

44. The apparatus (58) according to claim 43, wherein the outer casing (62) of the hydrocarbon converter (60) is free from fluid conduits (66) in a region facing to an adjacent C-converter (1, 1′).

45. The apparatus (58) according to claim 41 wherein at least one of the gaps (47) is connected to an inlet and to an outlet so as to pass a fluid therethrough.

46. A method for operating a C-converter (1) according to claim 30, which comprises a plurality of converter chambers (10), wherein each of the converter chambers comprises at least one filter (13), the filter (13) being adapted to filter particles from an aerosol comprising a first gas and particles containing carbon, wherein the first gas is hydrogen, wherein the method comprises the steps of:
alternately supplying an aerosol comprising hydrogen and particles containing carbon into at least one first converter chamber (10a) or at least one second converter chamber (10b), thereby trapping the particles from the aerosol in the filter (13) until a desired particle filling degree in the respective converter chamber (10a or 10b) is reached; and
alternately supplying a second gas into the at least one first converter chamber (10a) or the at least one second converter chamber (10b) so as to regenerate the corresponding converter chamber (10) by converting the previously trapped particles containing carbon into carbon monoxide, wherein
a) the second gas is CO₂ and the conversion is carried out according to the equation C+CO₂→2CO; or
b) the second gas is H₂O steam and the conversion is carried out according to the equation C+H₂O→CO+H₂.

47. The method according to claim 46, wherein, when the aerosol is supplied to the respective converter chamber (10), the second gas supply is blocked and the first gas is exhausted via a first converter chamber outlet, and when the second gas is supplied to the respective converter chamber (10), the aerosol supply is blocked and the carbon monoxide is exhausted via a second converter chamber outlet.

48. The method according to claim 46, wherein the desired particle filling degree is determined based on at least one of the following: a pressure drop across a converter chamber (10) supplied with aerosol, an increase in weight of a converter chamber (10) supplied with aerosol, by a fill sensor output, by a time period of supplying aerosol, and the current particle filling degree of another converter chamber.

49. The method according to claim 46, wherein the second gas is supplied until another desired particle filling degree, which is lower than the other particle filling degree, is reached.

50. The method according to any one of claim 46, wherein the C-converter (1) is continuously supplied with aerosol.

51. The method according to claim 46, wherein C is converted into CO at a temperature above 800° C., and wherein the at least one first converter chamber (10a) is heated at least partially by at least one of waste heat from at least one adjacent second converter chamber (10b), waste heat from a hydrocarbon converter (60) operated with plasma or with thermal energy and the aerosol.

52. The method according to claim 46, wherein gaps (47) are formed between the converter chambers (10), and wherein the method comprises the step of directing a fluid through the gaps (47) such that a heat exchange is effected between a fluid in the converter chambers (10) and the fluid in the gaps (47).

53. The method according to claim 46, wherein the aerosol and the second gas are supplied to the converter chamber (10) from opposite sides of the filter (13), and the first and second converter chamber outlets are arranged on opposite sides of the filter (13).

54. A method for operating an apparatus according to claim 39, wherein a fluid is directed through the gaps (47) between the converter chambers (10) of the C-converter (1, 1′) and/or the outer casing (62) of the hydrocarbon converter (60) such that a heat exchange is effected between a fluid in the converter chambers (10) and/or in the outer casing (62) and the fluid in the gaps (47).
